(19) United States
(12) Patent Application Publication
(10) Pub. No.: US 2025/0028282 A1
(43) Pub. Date: Jan. 23, 2025

(54) ANALOGUE DISPLAY ELEMENT

(71) Applicant: ETA SA MANUFACTURE HORLOGÈRE SUISSE, Grenchen (CH)

(72) Inventors: Stefan STARK, Prêles (CH); Olivier MAHLER, Fontaines (CH); Jérôme GROSJEAN, Pieterlen (CH); David Benjamin KRAEHENBUEHL, Bettlach (CH)

(73) Assignee: ETA SA MANUFACTURE HORLOGÈRE SUISSE, Grenchen (CH)

(21) Appl. No.: 18/761,855

(22) Filed: Jul. 2, 2024

(30) Foreign Application Priority Data
Jul. 18, 2023 (EP) 23186052.9

(51) Int. Cl. G04B 19/04

(52) U.S. Cl. CPC G04B 19/042

(57) ABSTRACT

A display element (1) intended to be fitted to a timepiece, including a body (2) provided with a portion (4) including an assembly area (5) configured to receive an insert (3) by embedding, the embeddable insert (3) being provided with a shaft hole (13) configured to adjust the display element (1) on a drive shaft, the body (2) including a portion (4) made of a material having the property of softening, in which the insert (3) is embedded by melting, the insert (3) including a peripheral wall (6) provided with a patterned outer surface (7a) for connection with the portion (4) of the body (2) of the display element (1), the outer surface (7a) being configured to ensure mechanical anchoring of the insert (3) in the portion (4), the peripheral wall (6) projecting, on either side respectively, from opposite faces of the portion (4) of the body (2).

### CROSS-REFERENCE TO RELATED APPLICATIONS

This application claims priority to European Patent Application No. 23186052.9 filed Jul. 18, 2023, the entire contents of which are incorporated herein by reference.

### TECHNICAL FIELD OF THE INVENTION

The invention relates to the field of watchmaking, and in particular to the field of analogue display elements such as a hand or a display disc of a timepiece.

The invention further relates to the timepiece comprising such a display element.

### Technological Background

The manufacture of a display element such as a hand intended for use as a display indicator in a timepiece is particularly complex, especially when the hand is intended for a top-of-the-range timepiece, for which the hand must have a particularly meticulous surface appearance, optionally with facets.

Hands are usually made of brass, steel, gold, aluminium or a special alloy. They can be galvanised, painted, oxidised, varnished, PVD-coated, blued/anodised or rough when the material used is gold. They are typically produced by machining or stamping and can undergo surface treatment, for example by polishing, sandblasting, satin-finishing, etc.

One drawback of these display hands is that the decorative possibilities thereof are limited, for example, when it comes to making hands with a transparent or translucent body. Moreover, the materials used for such hands have a high density, which implies a high moment of inertia and a high unbalance force, which result in the hand floating and the hand slipping during an impact, respectively.

One solution proposed in the prior art is that of manufacturing hands using synthetic materials. However, when such hands are assembled on a drive shaft, they have problems remaining attached to their pipe as a result of plastic deformation by creep.

### SUMMARY OF THE INVENTION

The main aim of the invention is to overcome the various drawbacks of prior art.

Another aim of the invention is to improve the hold of a display element, such as a hand having a non-metallic plate, on a drive shaft of a display mechanism of a timepiece.

Another aim of the invention is to provide a display element with a reduced weight and in any desired shape.

Another aim of the invention is to provide a display element that is robust over time and whose manufacturing cost is reduced.

To this end, one aspect of the invention relates to a display element intended to be fitted to a timepiece, comprising a body provided with a portion including an assembly area configured to receive an insert by embedding, said embeddable insert being provided with a shaft hole configured to adjust the display element on a drive shaft, the body comprising a portion made of a material having the property of softening, in which said insert is embedded by melting, said insert comprising a peripheral wall provided with a patterned outer surface for connection with said portion of said body of the display element, the outer surface being configured to ensure mechanical anchoring of the insert in said portion, said peripheral wall projecting, on either side respectively, from opposite faces of the portion of said body.

In other embodiments:
the peripheral wall is provided with a connecting outer surface of which a portion corresponding to the thickness of the assembly area is entirely patterned by comprising a plurality of relief patterns;
the insert comprises first and second parts projecting, on either side respectively, from opposite faces of the portion of said body;
the insert comprises first and second parts projecting, on either side respectively, from opposite faces of the portion of said body;
the first and second parts of the insert have similar thicknesses;
the free end of each of the first and second parts comprises insertion areas configured to pass through the material of the portion of said body in which said insert is embedded by melting;
the material having the property of softening comprises, in whole or in part, a plastic material having the property of softening;
said embeddable insert is made of a material having a softening point that is higher than a softening point of the material constituting said portion;
the portion comprises said insert embedded by melting/integration/association of the materials respectively constituting the insert and the portion, in particular by melting/integration/association by ultrasound;
the display element is symmetrical relative to a longitudinal plane of symmetry P1 and/or a transverse plane of symmetry P2 of this element;
the display element is a display hand whose body comprises a plate provided with the assembly area comprising a pipe formed by the embeddable insert.

Another aspect of the invention relates to a timepiece comprising at least one such display element.

### BRIEF DESCRIPTION OF THE FIGURES

Other features and advantages of the invention will be better understood upon reading the following description given of a non-limiting specific embodiment of the invention, provided for illustration purposes with reference to the accompanying figures, in which:

FIG. 1 is a top view of a display element, in this case a display hand comprising a plate provided with a portion comprising a pipe formed by an embeddable insert, according to one embodiment of the invention;

FIG. 2 is a top view of the portion of the hand plate comprising the pipe, according to the embodiment of the invention;

FIG. 3 is a longitudinal sectional view along line A-A of said portion of the hand plate shown in FIG. 2, according to the embodiment of the invention, and

FIG. 4 is a side view of the embeddable insert forming the pipe of the hand, according to the invention.

### DETAILED DESCRIPTION OF THE INVENTION

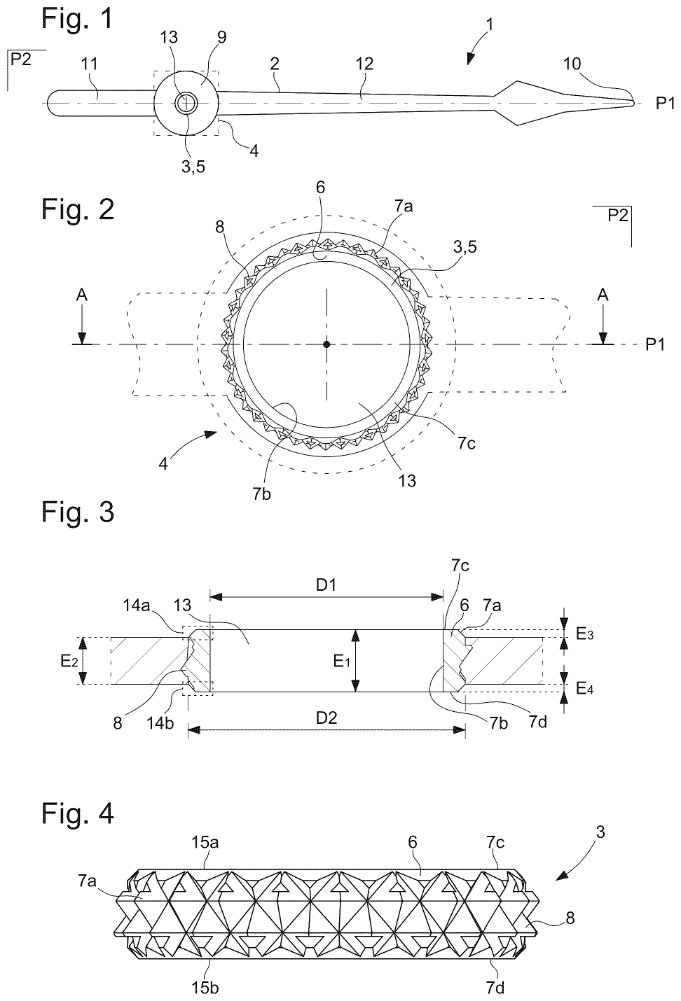

With reference to FIGS. 1 to 4, the invention relates to a display element 1 preferably for equipping a timepiece such as a wristwatch. Such an element 1 can be, but is not limited to, a hand or a display disc.

This display element 1, also referred to as a “display indicator”, comprises a body 2 provided with an assembly area 5 included in a portion 4 of this body 2, said assembly area 5 being configured to receive an insert 3 by embedding or insertion. In other words, said portion 4 and thus said area 5 are made of a material with the property of softening so that the insert 3 can be embedded (or inserted) therein by melting. Under these conditions, said assembly area 5 is then formed by this embeddable insert 3. Such an insert 3 comprises a shaft hole 13 configured to adjust this display element 1 on a drive shaft of a display mechanism of the timepiece.

For a better understanding of the invention, the display element 1 described here will be the display hand 1. In this context, the body 2 of this hand 1 comprises a plate 2. The portion 4 of this plate 2 includes the assembly area 5 comprising a pipe 5 formed by the embeddable insert 3. Such an insert 3, also referred to as a “socket”, is configured to be embedded by melting/association/integration in a portion 4 of the plate 2. The invention is described here in the particular, but non-limiting, case of a rotary hand 1. It should nevertheless be noted that the principle of the invention is also applicable to a hand 1 with a non-circular trajectory of motion, for example a linear cursor, or the like. This hand 1 can be included in a display mechanism, for example by being an hour hand, has a variable length or a variable radial extension.

With reference to FIG. 1, this display hand 1 comprises a first end including a counterpoise and a second opposite end forming a tip 10 indicating information such as, for example, a time when the display mechanism is a timepiece. As we have seen, the plate 2 of this hand 1 comprises a portion 4 provided with the pipe 5 including a shaft hole 13, also referred to as the “adjustment diameter”, intended to be driven at the pivot of the drive shaft of the display mechanism. Such a drive shaft is included in a drive member of the display mechanism including gear trains. It should be noted that the invention is equally applicable to analogue display mechanisms for a mechanical, electronic or hybrid timepiece.

According to the embodiment shown, the plate 2 has a circular head 9 in which the pipe 5 is housed to allow the hand 1 to be assembled on the drive shaft of the timepiece. The shaft hole 13 of the insert 3 forming the pipe 5 is intended to be adjusted on the drive shaft, by means of a driving operation for example.

This pipe 5, and thus the insert 3, is capable of exerting a clamping force on the drive shaft which allows the hand 1 to be held axially and rotatably on this drive shaft.

As already mentioned, the plate 2 further includes the tip 10. This tip 10 is connected to the head 9 by a body 12. Such a tip 10 in this case takes the shape of a triangle, but could take any other suitable shape in order to indicate a specific angular position on a dial of the timepiece.

The plate 2 of the hand 1 can further comprise a counterpoise 11, rectangular in shape, connected to the head 9 as an extension of the body 12. Similarly, the counterpoise 11 can take any other shape, for example it could be imagined that the counterpoise 11 takes the shape of a logo.

As mentioned above, the portion 4 comprising the assembly area 5 is made of a particular material. More typically, the plate 2 is made in whole or in part from this material which has the property of softening, such as a plastic material, in particular a thermoplastic material. Preferably, such a material is a rigid material with the property of softening. Under these conditions, this material can be heated sufficiently to soften and become rigid/hard again when cooled. This plastic material is composed of straight or branched chain polymers which are able to deform and be shaped under the effect of heat. This plastic material comprises, for example, thermoplastic polymers.

It is thus understood that this plate 2 can be made solely or entirely of this material having the property of softening. Alternatively, such a plate 2 can be partly made of this material with at least the portion 4 comprising the insert 3 being made of this material.

The pipe 5 is formed by the embeddable insert 3, which takes the form of a cylinder in which a shaft hole 13 is provided for adjusting the display hand 1 on the drive shaft, also referred to as the “rotary shaft”. It should be noted that such an insert 3 can take other forms, for example the form of a polygon. This insert 3 can be made of a material with a softening point higher than that of the material constituting the portion 4 where such an insert 3 is embedded. Such a material is preferably metallic, such as aluminium, brass, steel or titanium. Alternatively, this material can also be a thermosetting material.

Such an insert 3 forming this pipe 5 is intended to be forced onto the drive shaft which has a diameter slightly greater than the internal diameter of the shaft hole 13 of this insert 3, the elastic and plastic properties of the material of which it is made making it possible to drive the pipe 5 onto this drive shaft without altering the plate 2 of the display hand 1.

According to the invention, such an insert 3 comprises a peripheral wall 6 provided with an inner surface 7b suitable for cooperating with the drive shaft when assembled in the display mechanism. This peripheral wall 6 further comprises an outer surface 7a for connection with the portion 4 of the plate 2 of the display hand 1, in particular a patterned connecting outer surface 7a. This peripheral wall 6 further comprises upper and lower surfaces 7c, 7d which interconnect the outer and inner surfaces 7a, 7b.

This patterned outer surface 7a comprises a plurality of raised patterns 8. This plurality of patterns 8 preferably extends over the entire outer surface 7a of the peripheral wall 6. Alternatively, this plurality of patterns 8 can be distributed over particular areas of this outer surface 7a, which areas are configured to cooperate with the material constituting the portion 4 of the plate 2 of this hand 1. It should be noted that these patterns 8 can be identical, i.e. have a similar shape, as can be seen in FIGS. 2 and 4.

Such a patterned outer surface 7a helps to increase the contact surface of this insert 3 with the material used in the portion 4 of the plate 2 comprising the pipe 5. Moreover, in this configuration, the material can be inserted on and between the raised patterns 8 on this surface 7a to ensure that the plate 2 is held securely on this insert 3. It is thus understood that the hold of this insert 3 in this portion 4 is then improved and thus helps to ensure the optimal mechanical anchoring thereof in this portion 4.

It should be noted that the peripheral wall 6 of the insert 3 is preferably provided with a connecting outer surface 7a, a portion of which, corresponding to the thickness E2 of the portion 4 comprising the assembly area 5, is entirely patterned by comprising a plurality of raised patterns 8. In other words, this peripheral wall 6 comprises a plurality of raised patterns 8, this plurality extending over part of its patterned connecting outer surface 7a.

In one alternative embodiment, the peripheral wall 6 of the insert 3 is provided with a fully patterned outer surface 7a. In other words, this peripheral wall 6 comprises a plurality of raised patterns 8 which extends over all of its patterned connecting outer surface 7a.

As can be seen in FIG. 3, the insert 3 has an internal diameter D1 configured to help drive the hand 1 on the drive shaft, and an external diameter D2 that is greater than D1 and configured to receive and hold the plate 2 of the hand 1.

As already mentioned, this insert 3 is embedded by melting/integration/association in the portion 4 of the plate 2 in order to form the pipe 5 of this hand 1. More specifically, this insert 3 is embedded in this portion 4 as a result of an operation of melting/integrating/associating the materials constituting the insert 3 and the portion 4 respectively. This operation softens the material making up the portion 4 by supplying energy to ensure that the insert 3 is inserted into this portion 4. This energy can be supplied, in a non-limiting and non-exhaustive manner, by ultrasound or by a heating element, by a laser or by a steam jet.

In the case of using ultrasound, such an operation can be an ultrasonic melting/integration/association operation. This operation softens the material constituting the portion 4 by applying mechanical vibrations to said portion 4, said mechanical vibrations resulting from ultrasound. In this context, these mechanical vibrations will then generate frictional heat in the portion 4 of material with the property of softening, and excite its molecules, which will in turn start to move. Thus, the material of this portion 4 becomes more flexible as it softens, allowing the insert 3 to be inserted/embedded in this portion 4 and to bond to this material.

In this configuration, where the insert 3 is arranged in the plate 2 of the hand 1 to form the pipe 5, it should be noted that the peripheral wall 6 of the insert 3 projects on either side of the opposite faces of the portion 4 of said plate 2 of the display hand 1. These two opposite faces are joined together by a side wall of this hand 1.

More specifically, this peripheral wall 6 comprises first and second parts 14a, 14b projecting, on either side respectively, from opposite faces of this portion 4 of said body 2. These parts 14a, 14b each comprise an opening in the shaft hole 13 of the insert 3. It goes without saying that these openings are opposite each other. In this configuration, these first and second parts 14a, 14b of the insert 3 have thicknesses E3, E4 which are preferably similar. Such thicknesses E3, E4 are less than the thickness:
E1 of the insert 3;
E2 of the portion 4;
E2 of the assembly area 5.

Such an arrangement of the insert 3 in this portion 4 helps to stabilise the display hand 1 axially and rotatably. Moreover, this arrangement helps to even out the distribution of stresses to which the hand 1 may be subjected when it is assembled on the drive shaft as well as after it has been assembled on this shaft. In other words, such stresses are distributed uniformly over the entire thickness E2 of the body 2. This uniform distribution ensures that the body 2 of the hand and thus the portion given the reference numeral 4 remain flat. Thus, the body 2 of the hand 1 remains flat after assembly.

It is understood that such an arrangement of the insert 3 in the body 2 of the hand 1 allows a wider range of materials to be used, in particular by making it less necessary to use materials that are expressly reinforced to prevent deformation of the hand that can result from such stresses.

Moreover, the free end of each of such first and second parts 14a, 14b comprises insertion areas 15a, 15b. These areas are configured to pass through the material of the portion 4 of said body 2 in which said insert 3 is liable to be embedded by melting. More specifically, each insertion area 15a, 15b preferably has a cross-section with a flared shape with an end that terminates essentially in a tip.

It should also be noted that the display hand 1 is symmetrical relative to a longitudinal plane of symmetry P1 and a transverse plane of symmetry P2 of this hand 1. It is understood that these two planes P1, P2 are perpendicular to each other. By being symmetrical, such a display hand 1 is reversible, which helps to simplify and reduce the time taken to assemble it in a display mechanism. In other words, such a display hand 1 can be assembled on the shaft with a visible face which can be either of its two opposite faces.

The above description corresponds to a preferred embodiment and can under no circumstances be considered to be limiting, and more particularly as regards the type of display element described. More specifically, other display elements such as discs, in particular date discs, are also part of the invention.

Moreover, this description is also not limited to the form described for the various structural elements making up the display element 1 or their materials. A person skilled in the art will not have any particular difficulty in choosing, for example for the plate 2 of the hand 1, any other material with the mechanical properties necessary for the implementation of the present invention.

The possible applications for such a display element are very numerous, since the present invention can be implemented for any type of object or device, particularly a portable object or device, comprising a display element.

1. A display element (1) intended to be fitted to a timepiece, comprising a body (2) provided with a portion (4) including an assembly area (5) configured to receive an insert (3) by embedding, said embeddable insert (3) being provided with a shaft hole (13) configured to adjust the display element (1) on a drive shaft, the body (2) comprising a portion (4) made of a material having the property of softening, in which said insert (3) is embedded by melting, said insert (3) comprising a peripheral wall (6) provided with a patterned outer surface (7a) for connection with said portion (4) of said body (2) of the display element (1), the outer surface (7a) being configured to ensure mechanical anchoring of the insert (3) in said portion (4), said peripheral wall (6) projecting, on either side respectively, from opposite faces of the portion (4) of said body (2).

2. The display element (1) according to claim 1, wherein the peripheral wall (6) is provided with a connecting outer surface (7a) of which a portion corresponding to the thickness (E2) of the assembly area (5) is entirely patterned by comprising a plurality of relief patterns (8).

3. The display element (1) according to claim 1, wherein the insert (3) comprises first and second parts (14a, 14b) projecting, on either side respectively, from opposite faces of the portion (4) of said body (2).

4. The display element (1) according to claim 1, wherein the insert (3) comprises first and second parts (14a, 14b) projecting, on either side respectively, from opposite faces of the portion (4) of said body (2), the first and second parts (14a, 14b) of the insert (3) having thicknesses (E3, E4) which are similar.

5. The display element (1) according to claim 1, wherein the insert (3) comprises first and second parts (14a, 14b), the free end of each of these first and second parts (14a, 14b) comprising insertion areas (15a, 15b) configured to pass through the material of the portion (4) of said body (2) in which said insert (3) is liable to be embedded by melting.

6. The display element (1) according to claim 1, wherein the material having the property of softening comprises, in whole or in part, a plastic material having the property of softening.

7. The display element (1) according to claim 1, wherein said embeddable insert (3) is made of a material having a softening point that is higher than a softening point of the material constituting said portion (4).

8. The display element (1) according to claim 1, wherein the portion (4) comprises said insert (3) embedded by melting/integration/association of the materials respectively constituting the insert (3) and the portion (4), in particular by melting/integration/association by ultrasound.

9. The display element (1) according to claim 1, wherein it is symmetrical relative to a longitudinal plane of symmetry (P1) and/or a transverse plane of symmetry (P2) of this element (1).

10. The display element (1) according to claim 1, wherein it is a display hand whose body (2) comprises a plate (2) provided with the assembly area (5) comprising a pipe (5) formed by the embeddable insert (3).

11. A timepiece comprising the display element (1) according to claim 1.
